(19) United States
(12) Patent Application Publication
(10) Pub. No.: US 2026/0327400 A1
(43) Pub. Date: Oct. 22, 2026

(54) RECYCLING OF MEMBRANE COMPONENTS FOR FUEL CELLS AND ELECTROLYSERS

(71) Applicant: JOHNSON MATTHEY PUBLIC LIMITED COMPANY, London (GB)

(72) Inventors: Ross GORDON, Sonning Common (GB); Gareth HART, Sonning Common (GB)

(21) Appl. No.: 19/117,566

(22) PCT Filed: Nov. 21, 2023
(86) PCT No.: PCT/GB2023/053035

§ 371 Date: Apr. 1, 2025

(30) Foreign Application Priority Data
Dec. 15, 2022 (GB) 2218970.8

(51) Int. Cl. C08J 11/14; B29B 17/02; C08F 116/14

(52) U.S. Cl. CPC C08J 11/14; B29B 17/02; C08F 116/14; B29B 2017/0293

(57) ABSTRACT

A method of recycling fluorinated polymer from a waste membrane, the fluorinated polymer comprising a fluorinated polymer backbone chain and a plurality of groups represented by formula—SO₃Z, wherein Z is hydrogen or a cation, the method comprising: contacting the waste membrane with a liquid solvent to disperse the waste membrane in the solvent thus forming a dispersion of the fluorinated polymer in the liquid solvent; and freeze-drying the dispersion to produce a dry solid fluorinated polymer material.

### FIELD

This specification relates to recycling methods for components of membranes, such as those of catalyst coated membranes and membrane electrode assemblies used in fuel cells and hydrogen producing water electrolysers.

### BACKGROUND

Fuel cell and hydrogen producing water electrolyser production is set for rapid growth as investment is placed into the global hydrogen economy. Catalyst coated membranes (CCMs) are a major functional component of both fuel cells and electrolysers. Such CCMs generally comprise a conductive polymer membrane coated on either side by a catalyst containing layer. The CCMs are configured to drive oxidation and reduction reactions and support proton and electron transport, these processes been required for the fuel cell and electrolyser technologies to function.

While variations in CCM component materials and configurations exist according to functional performance requirements in end use applications, they generally contain several components of value including one or more platinum group metal (PGM) catalysts and one or more proton conducting polymers.

Typically, the membrane is formed of one or more ionomers such as perfluorosulfonic-acid (PFSA) ionomers. Ionomer may also be provided in one or both of the catalyst layers. The ionomer in the catalyst layers may be the same or different to the ionomer in the main membrane component and/or in other catalyst layer(s).

A CCM may comprise two different catalysts, one for driving an oxidation reaction on one side of the CCM and one for driving a reduction reaction on the other side of the CCM. A CCM may also comprise a recombination catalyst which is provided to catalyse the recombination of hydrogen and oxygen to form water, reducing the quantity of hydrogen crossing the membrane and mixing with oxygen to form a potentially explosive mixture. A CCM may also include a metal oxide (e.g., CeO₂) as a peroxide scavenger to slow degradation of the CCM and increase the lifetime of the CCM.

CCM catalysts can be based on platinum group metals such as platinum, ruthenium, iridium, palladium, or mixtures thereof. The platinum group metals may be provided in elemental (metallic) form, in compound form (e.g., an oxide, such as an iridium oxide catalyst), or as a PGM-base metal alloy (e.g., PtCo). Furthermore, the PGM catalyst materials may be supported on a substrate material (e.g., carbon, such as a platinum-on-carbon catalyst comprising particles of carbon on which platinum is disposed or PtCo-on-carbon).

Catalyst coated membranes (CCMs) can also be provided in combination with additional functional layers to form multi-layer membrane electrode assemblies (MEAs). Such MEAs may have 3, 5, or 7 layers for example.

With the increase in CCM manufacture for fuel cells and electrolysers, there is an associated increase in CCM waste materials, including a significant volume of scrap material created during CCM manufacture (e.g., due to failure at quality control) and also an increase in end-of-life (EoL) CCMs. Since CCMs contain several components which are rare and/or valuable, including platinum group metals (notably Pt, Pd, Ir and Ru) and ionomer (both in the membrane and catalyst layers), there is a growing demand for methods of recycling such components from scrap/waste CCM materials.

One current method to recover PGMs from production scrap and end-of-life CCM material involves incineration. The incineration process yields a PGM rich (typically Pt and Ir) ash which is processed via conventional PGM refining routes. However, the incineration process releases harmful and toxic gases such as CO₂ and HF from the polymers that are part of the membrane. Both these gases have negative impacts as they pollute the atmosphere, increase the greenhouse effect, and/or have harmful effects in the human body. As such, there is a need for a cleaner process which reduces or eliminates the emission of these gases.

In addition to the above, the incineration method destroys the ionomer component which also has significant value. As such, it would also be desirable to provide a process which is capable of recovering both PGM and ionomer components as well as providing a process which is cleaner, safer, and more environmentally friendly. Processes for recovering perfluorosulphonic acid ionomer are known. See, for example, WO2016/156815 and U.S. Pat. No. 7,255,798. Furthermore, processes for recovering individual PGM catalyst components are known. See, for example, U.S. Pat. No. 7,709,135. However, to enable fuel cells and electrolysers to become more sustainable technologies, there is a need for commercially viable and environmentally friendly routes to recover, separate, and recycle both the PGMs and the ionomer components from waste CCM materials including production scrap and end-of-life material. The present specification is concerned with a method for recycling ionomer materials (perfluorosulfonic acid (PFSA) polymers) from the ionomer membrane of a fuel cell or electrolyser, the method being compatible with also recovering catalyst materials from catalyst coated membranes comprising an ionomer membrane and catalyst coatings.

WO2021250576 discloses a process for recycling ionomer materials from the ionomer membrane of a fuel cell or electrolyser. It is described that the solubility of fluorinated polymers used in such membranes decreases when the fluorinated polymers are heat-treated, as may be the case during the fabrication of a membrane comprising the fluorinated polymers. That is, while fluorinated polymers having a fluorinated backbone chain and a plurality of groups represented by formula-SO3H or salts thereof dissolve easily in water and alcohol mixtures when they are newly prepared, after having been heated to temperatures of at least 100° C., these polymers are typically insoluble in water and water/alcohol mixtures at standard conditions. WO2021250576 discloses that such heat-treated fluorinated polymers are soluble when heated in the presence of water and a base. As such, WO2021250576 discloses a method which involves dissolving a fluorinated polymer membrane in water and a base to form a fluorinated polymer salt solution and then converting the fluorinated polymer salt solution back to a fluorinated polymer solution by hydrogen cation exchange. It is indicated that the base is typically an alkali metal hydroxide (e.g., lithium hydroxide, sodium hydroxide, or potassium hydroxide) or an ammonium hydroxide. It is further indicated that the moles of base used may be equivalent to the moles of the fluorinated polymer, or an excess of base may be used (e.g., an excess of up to 100, 200, or 300 mole percent of base to fluorinated polymer).

It is an aim of the present specification to provide an improved process for recycling fluorinated polymer membranes and particularly one which is more time and energy efficient and one which recovers ionomer in a form which is more suited for re-use in manufacturing new membrane material.

### SUMMARY OF INVENTION

Methods of recycling a fluorinated polymer from a fluorinated polymer membrane involve placing the membrane in a suitable liquid solvent in order to disperse the membrane material in the solvent either as a fluorinated polymer dispersion or a fluorinated polymer salt dispersion. If a solid product is required, then after dispersing the membrane material in a solvent, the dispersion can be thermally dried, optionally under reduced pressure, to remove the liquid solvent and achieve a dry, solid particulate product of fluorinated polymer or a fluorinated polymer salt. Such a dry, solid product may be desirable for purification, washing, storage, transportation, and/or as an intermediate product prior to re-dispersing the solid polymer material in another solvent for a membrane manufacturing method.

One problem with such a membrane recycling method is that dried fluorinated polymer (ionomer) materials recovered from waste fluorinated polymer membranes can take significant time and energy to re-disperse in order to achieve a stable dispersion which is suitable for use in further processing steps for manufacturing new membranes for fuel cells or electrolysers. This is due, at least in part, because the fluorinated polymer materials recovered from waste membranes tend to have a relative high density, high particle size, low porosity, and/or low surface area.

In accordance with the present specification there is provided a method of recycling fluorinated polymer from a waste membrane, the fluorinated polymer comprising a fluorinated polymer backbone chain and a plurality of groups represented by formula—SO₃Z, wherein Z is a cation, the method comprising: contacting the waste membrane with a liquid solvent to disperse the waste membrane in the solvent thus forming a dispersion of the fluorinated polymer in the liquid solvent; and freeze-drying the dispersion to produce a dry solid fluorinated polymer material.

It has been found that freeze drying can be utilized to recover solid ionomer material from waste fluorinated polymer membranes with a higher surface area and higher porosity. The recovered ionomer material can be more effectively dispersed in a shorter time frame than high density, thermally dried ionomer materials previously recovered from membranes. Freeze drying is a known process in which a dispersion is frozen and then the solid frozen solvent removed by sublimation. Freeze drying has also been mentioned in the context of manufacturing ionomer materials (see, e.g., WO2021111342). However, while freeze drying as a general technique is known, the present inventors are not aware that this technique has previous been proposed as a way to provide an improved process for recycling fluorinated polymers from waste membranes. The use of freeze drying enables an improvement in the energy efficiency of the recycling process and recovers ionomer in a form which is more suited for re-use in manufacturing new membrane material.

In addition to the above, is has also been noted that one problem with the methodology described in WO2021250576 is that use of a hydroxide base to form a dispersion of fluorinated polymer salt can cause several problems in the further processing of the ionomer material. Excess hydroxide base is corrosive to metal and glass lined vessels which may be used in a subsequent dispersion process at elevated temperature and pressure. Furthermore, excess hydroxide base can cause issues in speciation and extraction of other components, such as platinum group metal catalysts which are present in a catalyst coated membrane of a fuel cell or electrolyser. Further still, any excess hydroxide base needs to be recovered during the ion exchange process to convert the fluorinated polymer salt back to protonated acid form, which can adversely affect overall materials balance. The present freeze-drying methodology can be used to remove the water and base while also ensuring that the resultant solid ionomer (salt) material can readily be re-dispersed in another, less corrosive, solvent for further processing. Advantageously, prior to contacting the waste membrane with the liquid solvent to disperse the waste membrane in the solvent, the waste membrane is treated with a reagent providing a source of cations (e.g., an aqueous basic solution) to form a fluorinated polymer salt, wherein the reagent is maintained at a temperature sufficiently low that the waste membrane remains in a solid, undispersed form. Excess reagent can then be removed from the solid fluorinated polymer salt prior to dispersing the waste membrane in the liquid solvent. This ensures that excess reagent (e.g., excess base) is removed prior to freeze drying. The dispersion can be freeze dried in ionomer salt form or ionomer salt can be converted back to protonated form by ion exchange prior to freeze drying. This methodology is particularly advantageous as the conversion of water ionomer material to salt form enables a better dispersion of the ionomer prior to freeze drying of the ionomer dispersion. This subsequently results in a more dispersible freeze-dried ionomer product. While freeze drying has been shown to be useful in producing a dispersible product, if the waste ionomer material is not well dispersed prior to the freeze-drying process, then the resultant freeze-dried product does not have good dispersion properties. As such, to achieve a good dispersible product which is also free from contaminants, an advantageous process flow is to: (i) convert the waste ionomer material to salt form using a reagent providing cations without dispersing the ionomer (keeping the temperature below that which disperses the ionomer, e.g., below 150° C., 100° C., or 80° C.); (ii) remove excess reagent; (iii) disperse the salt form of the ionomer material by heating in a solvent (e.g., above 180° C., 200° C., or 240° C.); (iv) optionally convert the salt form of ionomer back to protonated form by ion exchange; and (v) freeze dry the ionomer material. This process flow leads to a better ionomer product material when starting from a waste ionomer material both in terms of dispersibility and purity.

Accordingly, the present process provides an improved method for recycling of scrap or used membranes of fuel cells or electrolysers.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a flow diagram of the method steps for recycling a waste fluorinated polymer membrane including a waste membrane dispersal step and a freeze-drying step;

FIG. 2 shows a flow diagram of the method steps for recycling a waste fluorinated polymer membrane including a waste membrane dispersal step, a freeze-drying step, an ionomer re-dispersal step, and use of the dispersion to manufacture a new fluorinated polymer membrane;

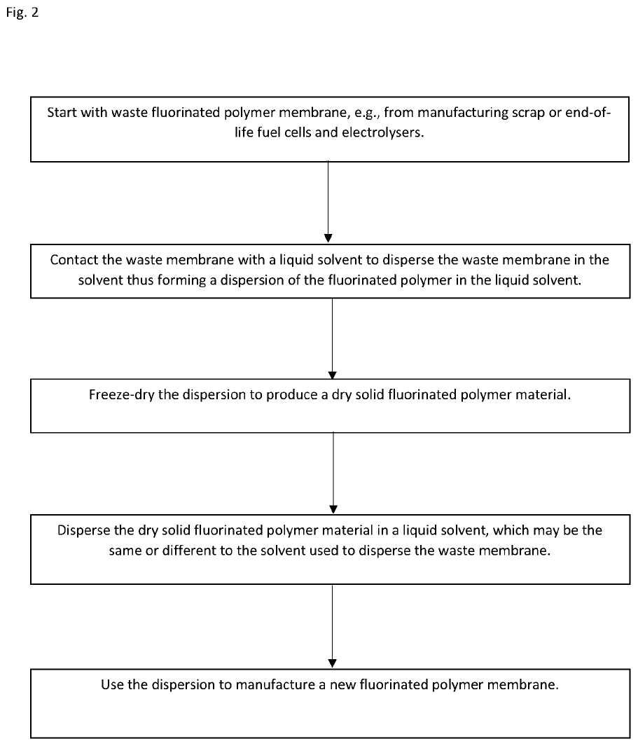

FIG. 3 shows another example of the method steps for recycling a waste fluorinated polymer membrane including a fluorinated polymer salt forming step, a membrane dispersal step, a freeze-drying step, a further ionomer dispersal step, and a cation exchange step prior to using the fluorinated polymer to manufacture a new fluorinated polymer membrane;

FIG. 4 shows an example of the method steps for recycling a catalyst coated waste fluorinated polymer membrane including separating catalyst material from the waste fluorinated polymer membrane prior to dispersal of the membrane and freeze drying the dispersion; and

FIG. 5 shows an example of the method steps for recycling a catalyst coated waste fluorinated polymer membrane including dispersing of the membrane followed by separating catalyst material from the dispersal and then freeze-drying the dispersion.

### DETAILED DESCRIPTION

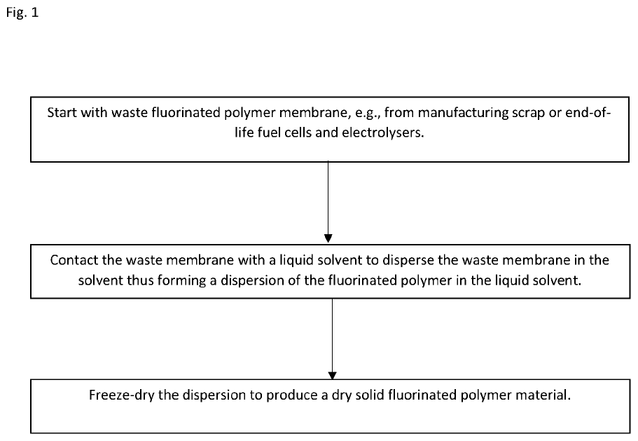

As illustrated in FIG. 1, the present specification provides a method of recycling fluorinated polymer from a waste membrane, e.g., scrap or end-of-life fluorinated polymer membrane material from fuel cells and electrolysers. Such fluorinated polymer membranes are formed of fluorinated polymer comprising a fluorinated polymer backbone chain and a plurality of groups represented by formula—SO₃Z, wherein Z is a cation, e.g., a hydrogen, a metal cation, or an ammonium cation. The method comprises contacting the waste membrane with a liquid solvent to disperse the waste membrane in the solvent thus forming a dispersion of the fluorinated polymer in the liquid solvent. The fluorinated polymer dispersion is then freeze-dried to yield dry solid fluorinated polymer material.

The freeze-drying step comprises cooling the dispersion to, or below, a temperature at which the liquid solvent freezes to form a frozen solid, and reducing a pressure above the frozen solid to, or below, the pressure at which the frozen solid solvent sublimes to yield the dry solid fluorinated polymer material. For example, the dispersion may be cooled to a temperature of less than −20° C., 30° C., −40° C., −50° C., −60° C., or −70° C. to freeze the liquid solvent, optionally no less than −200° C. or −100° C. Furthermore, the dispersion is maintained a temperature of less than −10° C., −20° C., −30° C., −40° C., or −50° C., optionally no less than −200° C., −100° C., −70° C., or −60° C., during sublimation of the solvent. Further still, the pressure is maintained below 1 mbar, 0.1 mbar, 0.01 mbar, or 0.005 mbar during sublimation of the solvent. The precise temperature and pressure values utilized will depend on the nature of the solvent used to form the dispersion and the operating capabilities of the freeze-drying equipment.

The liquid solvent can be an organic solvent such as an alcohol or a diol, optionally mixed with water. Alternatively, the liquid solvent can be an aqueous solvent.

The dry solid fluorinated polymer material optionally has a BET surface area of less than 1g/m² . The dry solid fluorinated polymer material can subsequently be dispersed in a solvent, which may be the same or different to the solvent used to disperse the waste membrane, and the dispersion used to manufacture a new fluorinated polymer membrane. The dispersion optionally has a viscosity at 1 s- 1 of less than 1000 cps, less than 500 cps, or less than 300 cps. The freeze-dried solid fluorinated polymer material recovered from waste membrane is easier to disperse than previous forms of solid fluorinated polymer material recovered from waste membrane. Accordingly, it requires less energy and time to form a suitable dispersion and is thus better suited for re-use in manufacturing new membranes.

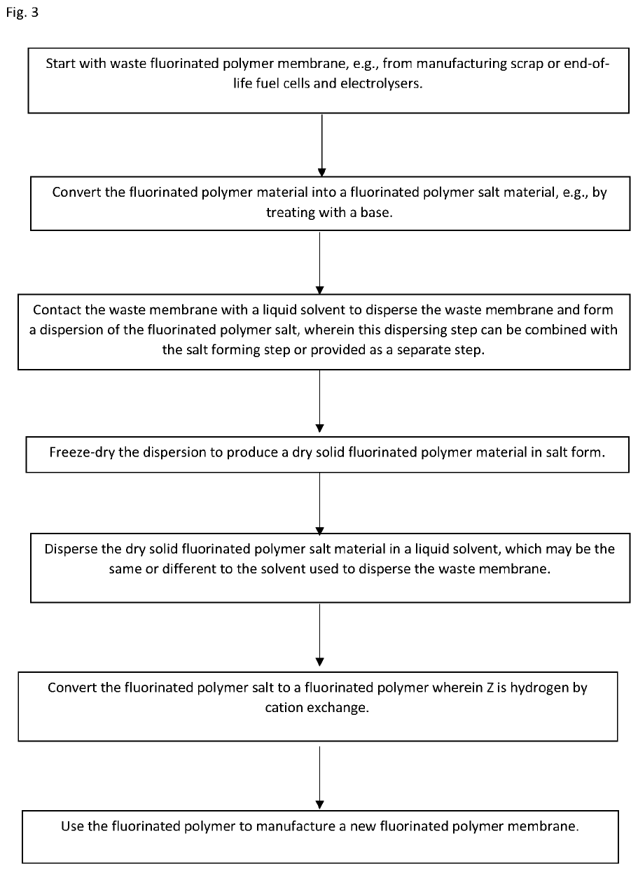

The fluorinated polymer in the dispersion and/or in the dry solid fluorinated polymer material can be in salt form or protonated acid form. FIG. 3 shows a method of recycling a waste fluorinated polymer membrane in which the fluorinated polymer is converted into salt form, the membrane is dispersed, and the dispersion is freeze dried to produce a dry solid fluorinated polymer material in salt form. The fluorinated polymer in the membrane can be converted to salt form prior to dispersal of the membrane. Alternatively, the fluorinated polymer in the membrane can be converted to salt form during dispersal of the membrane. The salt conversion can be achieved, for example, utilizing a solvent which comprises water and a base, wherein the base reacts with the sulfonic acid groups of the fluorinated polymer to form a fluorinated polymer salt. The base may be a hydroxide such as a metal hydroxide or an ammonium hydroxide. At low temperatures (e.g., room temperature or only moderate heating), the conversion to salt form can be achieved without dispersing the membrane. If heated (e.g., over 180° C. under pressure) the membrane can be dispersed. Converting the ionomer to salt form prior to dispersion is useful as excess base can be removed and then the salt form of the base forms a better dispersion. This better dispersion which is not contaminated with excess base can then be freeze-dried to form a highly dispersible solid fluorinated polymer salt material.

The freeze-dried solid fluorinated polymer salt material can subsequently be used to manufacture new membrane material. In this regard, the fluorinated polymer salt material can be dispersed in a solvent, converted to protonated acid form via cation exchange, and then used to manufacture new membrane.

This method is similar in some respects to the method described in WO2021250576 in that it can use a water and base, such as a hydroxide, to form a fluorinated polymer salt. However, excess hydroxide base is corrosive to metal and glass lined vessels which may be used in a subsequent dispersion process at elevated temperature and pressure. Furthermore, excess hydroxide base can cause issues in speciation and extraction of other components, such as platinum group metal catalysts which are present in a catalyst coated membrane of a fuel cell or electrolyser. Further still, any excess hydroxide base needs to be recovered during the ion exchange process to convert the fluorinated polymer salt back to protonated acid form, which can adversely affect overall materials balance. As such, it is preferred that the fluorinated polymer membrane is converted to a salt without dispersing the membrane. The base can then be removed, and the membrane then be dispersed in a non-basic solution (e.g., water) prior to freeze-drying. The resultant solid ionomer (salt) material can readily be re-dispersed in another solvent for further processing. It may be noted that as an alternative to the use of a base such as a hydroxide as the source of cations to form the polymer salt other reagents can be used such as carbonates, halide salts, etc.

The solid fluorinated polymer salt formed by freeze-drying can be stored as an intermediate product until it is needed for use in producing new fluorinated polymer or converted immediately into fluorinated polymer. In this regard, the fluorinated polymer salt can then be dispersed prior to the step of converting the fluorinated polymer salt to the fluorinated polymer by cation exchange. After converting the fluorinated polymer salt to the fluorinated polymer by cation exchange, the fluorinated polymer can be re-used to manufacture a new membrane.

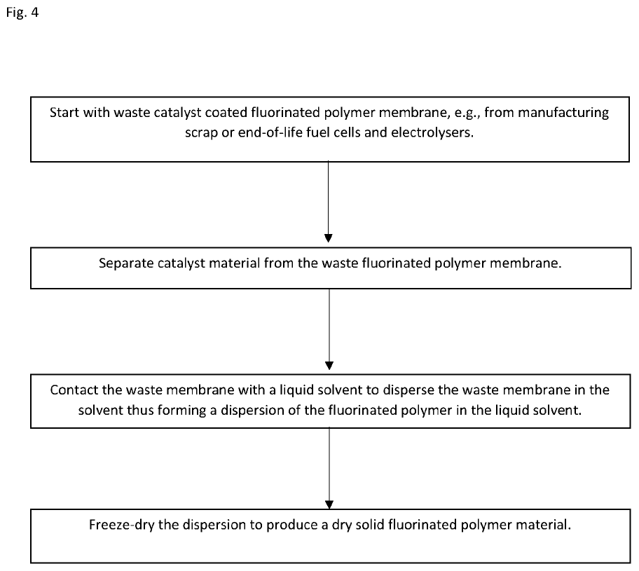

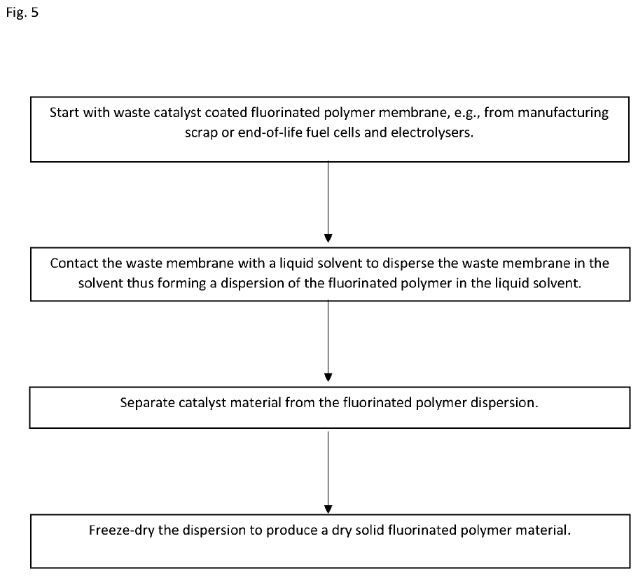

The membrane can be a catalyst coated membrane for a fuel cell or electrolyser. In this case, it is desirable to recycle the catalyst components and the polymer material of the membrane. As such, at least one catalyst material can be separated from the membrane prior to dispersal of the membrane (e.g., by delamination or leaching) and/or at least one catalyst material can be separated after dispersal of the membrane (e.g., via a solid-liquid separation such as filtration). Such process flows are illustrated in FIGS. 4 and 5.

### Experimental

A dispersion of solid PFSA ionomer in water (89.67 g) was formed by autoclaving a fuel cell ionomer membrane in water. The dispersion was frozen over dry ice (~−78° C.) before the water was sublimed (using a Christ Alpha 1-2 LDPLUS −55° C. Freeze Dryer) for 43 hours at ~0.002 mbar to yield a fluffy, off-white PFSA ionomer solid material (8.72 g). The solid ionomer product material had a low density, high porosity, and high surface area and is readily dispersible for use in manufacturing ionomer membranes or for incorporation into catalyst ink formulations for catalyst layer fabrication, e.g., for catalyst coated membranes of fuel cells or hydrogen producing electrolysers.

A similar freeze-drying experiment has also been performed on a dispersion formed from an autoclave process on a leached fuel cell catalyst coated membrane. To leached catalyst-coated membrane (2.71 g) was added water (60 mL). This mixture was heated at 250° C. for 3 hours to produce an ionomer dispersion and remaining solids containing reinforcement, residual catalyst and residual ionomer. The dispersion was filtered, frozen over dry ice and freeze-dried for 48 hours using a Christ Alpha 1-2 LDplus freeze-dryer to yield a fluffy, off-white solid (0.89 g).

While this invention has been particularly shown and described with reference to certain examples, it will be understood to those skilled in the art that various changes in form and detail may be made without departing from the scope of the invention as defined by the appended claims.

1. A method of recycling fluorinated polymer from a waste membrane, the fluorinated polymer comprising a fluorinated polymer backbone chain and a plurality of groups represented by formula —SO₃Z, wherein Z is hydrogen or a cation, the method comprising:
contacting the waste membrane with a liquid solvent to disperse the waste membrane in the solvent thus forming a dispersion of the fluorinated polymer in the liquid solvent; and
freeze-drying the dispersion to produce a dry solid fluorinated polymer material.

2. The method according to claim 1,
wherein the fluorinated polymer in the dispersion is in salt form.

3. The method according to claim 2,
wherein, prior to contacting the waste membrane with the liquid solvent to disperse the waste membrane in the solvent, the waste membrane is treated with a reagent providing a source of cations to form a fluorinated polymer salt, wherein the reagent is maintained at a temperature sufficiently low that the waste membrane remains in a solid, undispersed form; and
excess reagent is removed from the solid fluorinated polymer salt prior to dispersing the waste membrane in the liquid solvent.

4. The method according to claim 2,
the method further comprising converting the dispersed fluorinated polymer salt to a fluorinated polymer wherein Z is hydrogen by cation exchange prior to freeze-drying.

5. The method according to claim 2,
wherein the fluorinated polymer salt is freeze-dried.

6. The method according to claim 1,
wherein the fluorinated polymer in the dispersion and in the dry solid fluorinated polymer material is in protonated acid form.

7. The method according to claim 1,
wherein the liquid solvent is an organic solvent or an aqueous solvent.

8. The method according to claim 1,
wherein the dry solid fluorinated polymer material has a BET surface area of less than 1 g/m².

9. The method according to claim 1,
further comprising dispersing the dry solid fluorinated polymer material in another solvent to produce a dispersion for further processing.

10. The method according to claim 9,
wherein the dispersion has a viscosity at 1 s⁻¹ of less than 1000 cps, less than 500 cps, or less than 300 cps.

11. The method according to claim 9,
wherein the dry solid fluorinated polymer material is in salt form and wherein, after dispersing the dry solid fluorinated polymer material in the other solvent, the method further comprises converting the fluorinated polymer salt to a fluorinated polymer wherein Z is hydrogen by cation exchange.

12. The method according to claim 1,
wherein the freeze-drying step comprises cooling the dispersion to, or below, a temperature at which the liquid solvent freezes to form a frozen solid, and reducing a pressure above the frozen solid to, or below, the pressure at which the frozen solid solvent sublimes to yield the dry solid fluorinated polymer material.

13. The method according to claim 12,
wherein the dispersion is cooled to a temperature of less than −20° C., −30° C., −40° C., −50° C., −60° C., or −70° C. to freeze the liquid solvent.

14. The method according to claim 12,
wherein the dispersion is maintained at a temperature of less than −10° C., −20° C., −30° C., −40°C, or −50° C. during sublimation of the solvent.

15. The method according to claim 12,
wherein the pressure is maintained below 1 mbar, 0.1 mbar, 0.01 mbar, or 0.005 mbar during sublimation of the solvent.

16. (canceled)
